(19) United States
(12) Patent Application Publication
(10) Pub. No.: US 2006/0186346 A1
(43) Pub. Date: Aug. 24, 2006

(54) Method and system for reading microarrays

(75) Inventor: Pei-Kuen Wei, Taipei (TW)

Correspondence Address: COHEN, PONTANI, LIEBERMAN & PAVANE, 551 FIFTH AVENUE, SUITE 1210, NEW YORK, NY, 10176, US

(73) Assignee: Academia Sinica

(21) Appl. No.: 11/061,672

(22) Filed: Feb. 18, 2005

(51) Int. Cl. G01N 21/64

(52) U.S. Cl. 250/461.2; 250/361 C

(57) ABSTRACT

The present invention is a method for providing light onto a thin light transparent substrate comprising the steps of passing noncoherent light through a fiber optic line light guide to produce line light; and impinging the line light onto the edge of the substrate to produce an evanescent planar wave on the surface of the substrate. This method is specifically useful in reading fluorescent signals from microarrays placed on a light transparent substrate.

### FIELD OF THE INVENTION

The present invention is in the field of optical reading method and system that can read the fluorescent signals of microarrays on a thin transparent substrate, and more specifically optical reading method and system that can read the fluorescent signals of DNA microarrays on a thin glass slide.

### BACKGROUND OF THE INVENTION

In DNA microarray chips, different kinds of DNA probes were placed on the surface of glass substrate by using chemical bonding or physical adsorption methods. The target genes labeled with fluorescent dyes, such as Cy3, Cy5, were hybridized with the microarrays. Due to the specific interactions between the DNAs, the target genes and DNA probes bond together when their pairs are matched. Those mismatched pairs are washed away. Hence, by detecting the fluorescent signals in the chip, the DNA microarrays can determine the contents of target genes in a short period of time. The widely used DNA microarrays have tens of thousand of different DNA sequences, thus they are able to express different kinds of genes. The DNA microarray chips are important tools in modem gene therapies and gene studies. See Blanchard, A. P. & L. Hood. “Sequence to array: probing the genome's secrets” Nature Biotechnology 14:1649, 1996. For the use of microarray chips, the fluorescent detection is an important process. They must have the ability of large area detection containing tens of thousand DNA probes and high sensitivity for detecting small amounts of the target genes.

There are two state-of-the-art technologies for the DNA microarray readers. See J. Cortese, “Microarray readers: Pushing the envelope,” The Scientist, 15[24]:36, Dec. 10, 2001. One is based on the laser confocal excitation with photomultiplier tube (PMT) detection and the other is white light source excitation with charge-coupled device (CCD) detection. The laser confocal excitation uses an objective to excite the fluorescent dyes in the focal spot. The fluorescent signals pass through a pinhole, which is placed at the confocal point of the objective, and then be detected by the PMT. The PMT converts the optical intensity signals to electronic signals. The pinhole acts a spatial filter and only the signal at the focal spot can pass through the pinhole. The confocal setup has the advantages of high spatial resolution and sensitive detection at the focal point. For example, U.S. Pat. No. 6,603,780 discloses a laser-applied apparatus comprising: a DNA examination apparatus, and a laser apparatus to supply, selectively, a plurality of laser beams of 30 nm or more in wavelength difference to said examination apparatus, said laser apparatus comprising optical fibers through which said laser beams pass, and a switching and coupling unit connected to said optical fibers to select at least one laser beam from a plurality of laser beams. However, the setup needs to scan the sample point by point. For DNA microarrays, there are tens of thousand micron spots on the substrate. Hence it will take a long time to scan all the microdots. To increase the scanning speed, the laser power needs to be increased. Nevertheless, the energy of then focused laser is usually so high as to photobleach the fluorescent dyes. Furthermore, the confocal laser scanning method will cause position errors when multiple scans are required.

The other method uses a white light source to excite the dyes. Compare to the laser system, the broadband light source can select the excitation wavelength by using different wavelength filters. There is no need for changing the light sources. The white source was filtered to select a suitable wavelength range for fluorescent excitation. By uniformly illuminating the microarrays chips with the light source, the fluorescent images were taken by using large aperture lens and low noise CCD. The CCD method can simultaneously take the image of DNA microarrays, hence there are no scanning units here. The reading time is short and no position errors occurred when multiple readings are required. For example, see U.S. Pat. Nos. 6,496,309; 6,794,658; 6,271,042; and PCT WO 00/12759. U.S. Pat. No. 6,496,309 discloses a system for automated imaging of samples, comprising: a) an automated stage for storage and transportation of one or more of said samples in a viewing area; b) an arc lamp providing a source of excitation light; c) a first optical subsystem transmitting said excitation light to a sample in said viewing area, wherein said first optical subsystem includes a telescope; d) an excitation filter wheel containing one or more excitation filters to select the desired wavelength of said excitation light; e) a CCD camera; f) a second optical subsystem transmitting emission light from said sample exposed to said excitation light to said camera; and g) an emission filter wheel containing one or more emission filters to select the desired wavelength of said emission light. U.S. Pat. No. 6,271,042 discloses a biochip detection system that includes a charge coupled device (CCD) sensor, a broad spectrum light source, a lens, a light source filter, and a sensor filter. It illuminates the broadband light onto a glass slide simply by oblique incidence. This method suffers from lower power density (power/area, the area is L×W) and large background light. The excitation light is distributed over a large area. Its energy is much smaller than that of confocal laser scanning method. Unlike the confocal excitation, there are many excitation light reflected to the CCD. The large excitation background reduces the sensitivity of the fluorescent detection.

Additionally, U.S. Patent Application (Pub. No.: US2001/0003043; published Jun. 7, 2001) discloses a method and device for parallel detection and analysis of fluorescently labeled biopolymer molecules on a two-dimensional array using lasers for consecutive specific excitation to cause total internal reflection and a charge couple device for emission detection. In publication no. 2001/0003043, the inventors used laser to excite the fluorescent tags. Although they used total internal reflection fluorescence (TIRF) method to do the excitation, the laser excitation has inherent problems: First, laser light sources utilized within the detection devices inherently only emit light waves which span over an extremely narrow range of wavelengths. Fluorescent tags are generally responsive to a single frequency of light or light from a narrow frequency band. Thus, the use of the laser light sources severely limits the flexibility of those detection devices because only one type of fluorescent tag can be used. To use other tags, additional laser sources must be used. Since laser light sources are costly and specialized items, there are substantial costs and inconveniences associated with utilizing these prior detection devices. Furthermore, the widely used laser has power ˜10 mW. If we make the laser into fan shape (e.g. by cylindrical lens) and coupled it into 0.7 mm thick and 1″ wide glass slide from the edge, the power density is 10 mw/0.7 cm/2.54 cm˜0.0056 W/cm². This is a quite small value to effectively excite the fluorescent tags. Hence it is not practical to use a laser for wide area illumination. Further, to illuminate a large area of the slide surface, multiple total internal reflections of laser beam and overlap between the reflected laser beams are required. Since laser has a long coherent length, its overlap will cause severe interference pattern. This results in the surface not being uniformly illuminated.

### SUMMARY OF THE INVENTION

It is the main purpose of this invention to resolve the problems of low excitation intensity and large excitation background evident in previous CCD detection methods.

In accordance with one aspect of the present invention there is provided a method for generating an uniform light guided onto a substrate, comprising the steps of changing a circular light into a line shape by a fiber optic line light guide and launching the line light into the slide by an end-fire coupling method. See R, G. Hunsperger, Integrated Optics: Theory and Technology, Springer-Verlag, New York.

There can be microarrays in the substrate. The said method may further comprise the steps of collecting the fluorescence of the microarrays excited by the uniform light on the substrate surface by a lens; choosing the light of desired passing wavelength by a bandpass filter and reading the image of the fluorescence by a camera.

More specifically, the camera is a CCD camera; the microarrays can be DNA microarrays, protein microarrays, fluorescent-labeled compounds, electrophoresis gels, chromatography plates, radioisotopes, histological samples, toxicology samples or antibodies; and the substrate can be glass slide, quartz, ZnO, ZrO₂ or other transparent materials.

In accordance with another aspect of the present invention there is provided a system for reading microarrays, comprising: a. a light source emitting an excitation light; b. a filter wheel selecting the light of desired wavelength; c. a first fiber optic line light guide changing a circular light into a line light, wherein the line light is launched into a substrate by end-fire coupling method to form an evanescent wave; d. a lens collecting the fluorescence of the microarrays excited by the evanescent wave on the substrate surface; e. a bandpass filter wheel choosing the light of desired passing wavelength and f. a camera reading the image of the fluorescence.

More specifically, the camera is a CCD camera; the light source can be Hg lamp, Xe lamp or Tungsten-Halogen Light; the microarrays can be DNA microarrays, protein microarrays, fluorescent-labeled compounds, electrophoresis gels, chromatography plates, radioisotopes, histological samples, toxicology samples or antibodies; the substrate can be glass slide, quartz, ZnO, ZrO₂ or other transparent material.

The system can further comprise a second fiber optic line guide, wherein said first fiber optic line light guide and second fiber optic line guide are used at the opposite edges of the glass slide.

The present invention does not directly expose the DNA microarrays to the white light source. Instead, it launches the light into the thin glass slide. The excitation light is confined in the glass by the total internal reflection (TIR) effect. The fluorescence in the microarrays results from excitation by the surface evanescent planar wave (EPW) present in the TIR region. Because the light is confined in the thin glass, the optical intensity is increased. Furthermore, the EPW exists only in the near-field region of the glass surface. It decays very quickly in the air. The fluorescent dyes on the glass surface can be excited by the EPW and then radiate to the far-field region. Hence, the excitation background is greatly reduced and the signal to noise ratio is increased.

These and other aspects, objects, features, and advantages of the present invention will be more clearly understood and appreciated from a review of the following detailed description of the preferred embodiments and appended claims, and by reference to the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

We present a new method to illuminate the microarrays on thin glass slides by broadband light source. Compared to prior art, our method take advantages of high power density (at least one order of magnitude larger), low back-ground noise and higher sensitivity.

### BRIEF DESCRIPTION OF THE DRAWINGS

In the detailed description of the preferred embodiments of the invention presented below, reference is made to the accompanying drawings in which:

FIG. 1a is a schematic showing the system of the present invention which has one line guide.

FIG. 1b is a schematic showing the fiber optic line light guide.

FIG. 2 is a schematic showing the system of the present invention which has dual line guides.

FIG. 3a is a schematic showing the end-fire coupling method for launching light into the glass slide.

FIG. 3b is a schematic showing the photo where white light was coupled into the glass slide by using the fiber optical line guide and end-fire coupling method.

FIG. 4a is a schematic showing the setup for EPW measurement.

FIG. 4b is a schematic showing the measured intensity as a function of z-position in the air region.

FIG. 5a is an image showing the result for large area test.

FIG. 5b is an image showing the sensitivity test.

FIG. 5c is a photo showing the fluorescent image of 0.006 flours/μm² of Cy3.

### DETAILED DESCRIPTION OF THE PRESENTLY PREFERRED EMBODIMENTS

The invention has been described in detail with particular reference to certain preferred embodiments thereof, but it will be understood that variations and modifications can be effected within the spirit and scope of the invention.

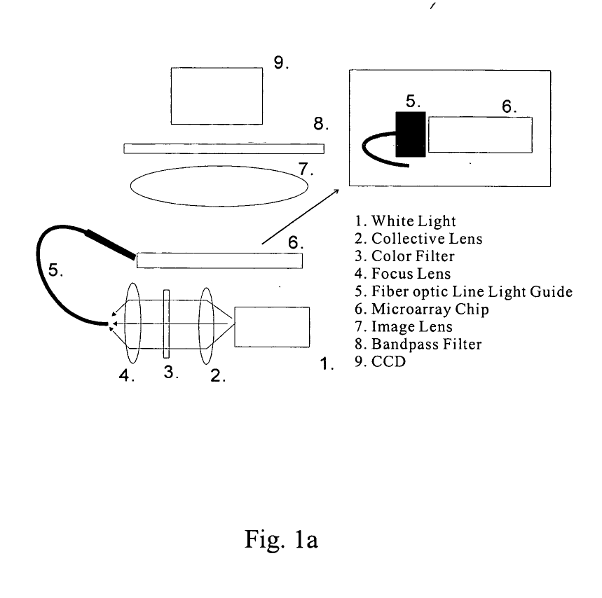

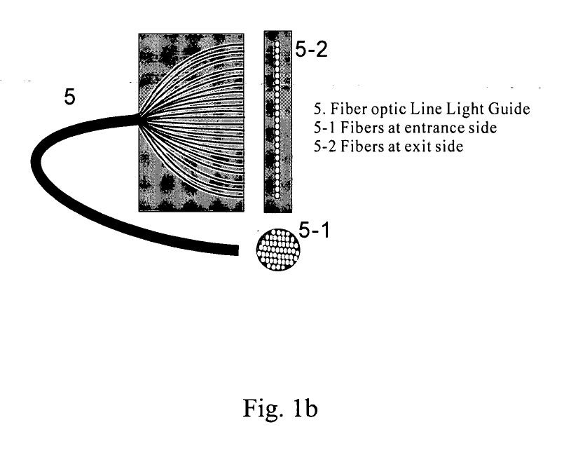

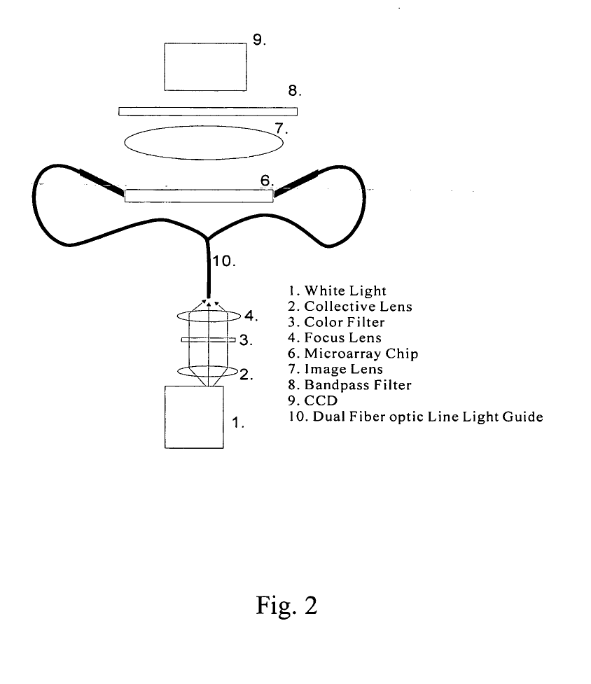

The present invention provides a simple and efficient excitation means and highly sensitive detection of fluorescent DNA microarrays in a CCD based microarray reader. The key technologies are to confine white light source in thin glass substrate and excite the fluorescent dyes by the surface evanescent planar wave. FIG. 1a shows a setup for our method. The light source was a 150 W Hg lamp. A wavelength filter is used here to select the wavelength regions for exciting the fluorescent dyes. For Cy3 dyes, wavelengths from 520 nm to 550 nm in the broadband white light are selected. The light source was coupled into a fiber optical line guide. The line guide, shown in FIG. 1b, has a plurality of fibers arranged in a circle in the input end. The round arranged fibers were then rearranged into a line in the output end. This fiber guide reshaped the centimeter circular input light into centimeter line source. The line source was launched into the thin glass substrate by end-fire coupling method. Instead of using only one line in the output end, we can also use dual optical fiber light line guides. The line guides have a larger input diameter and two separate lines at outputs. This configuration can double the excitation light intensity. The dual line guides excitation is shown in FIG. 2.

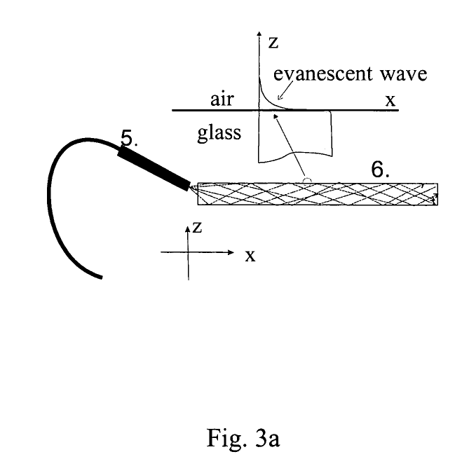

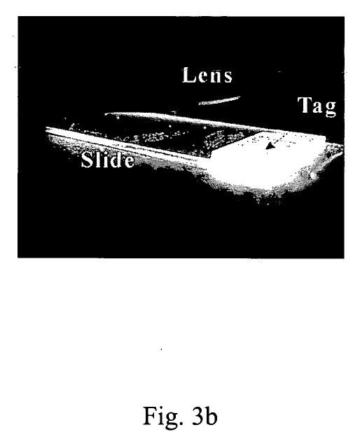

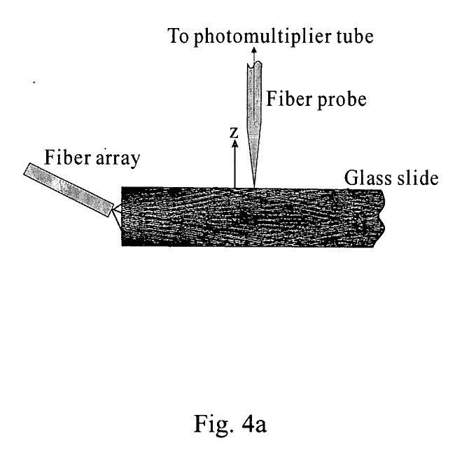

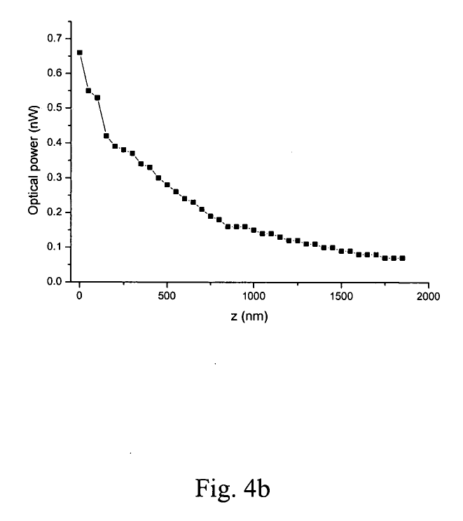

The end-fire coupling method for launching light into the glass slide is shown in FIG. 3a. There is a small incident angle between the fiber axis and normal direction of the end face of the substrate. The angle is smaller than the total internal reflection angle (˜22°) to sufficiently confine the light in the glass slide. In this method, most of light is confined in the glass slide. Little light propagates to the outside. FIG. 3b shows the photo where white light was coupled into the glass slide by using the fiber optical line guide and end-fire coupling method. It can be seen that most light is confined in the slide and exits from the end faces. We can see bright light in the tag area. The bright light is due to the scattering of surface planar evanescent wave by the tag. To further determine the existence of EPW, we have measured the optical intensity in the near-field region of glass surface. FIG. 4a is the setup for EPW measurement. See P. K. Wei, and W. S. Fann, “Large Scanning Area Near-Field Optical Microscopy” Review of Scientific Instrument, No. 10, p. 3614 (1998). A tapered optical fiber is placed in proximity to the glass surface. The optical intensity was collected by the fiber and sent to a PMT. By varying the z position of the fiber probe, we can detect the optical intensity distribution along the surface. FIG. 4b shows the measured intensity as a function of z-position in the air region. Clearly, we can see an exponentially decay of light. This confirms the existence of the EPW. The light intensity on glass surface is one order of magnitude larger than the light 2 μm away from the surface.

When microarrays are fabricated on the surface of glass slide, their fluorescent signals then can be excited by the EPW. As mentioned above, the EPW only exists on the surface, the excitation background is reduced. Furthermore, the input white light is confined in the thin glass slide, the optical intensity is much stronger than directly exposing the microarrays to white light. For example, the prior art (such as U.S. Pat. No. 6,271,042) teaches the illumination of broadband light onto the whole glass surface. The illumination area is W×L, where W is the width and L is length. In our configuration, the power is confined on the thin glass slide, the area is W×H. where H is the slide thickness. Hence, our power density is L/H times larger than that of prior art. For L=50.8 mm and H=0.7 mm, our configuration has a power density ˜70 times larger that that of prior art.

The fluorescent image can be taken by using large aperture lens and a low noise CCD. To test the sensitivity and area uniformity of our invention, we detected DNA microarrays consisting of different concentrations of DNA labeled with Cy3. The light source was a 150 W Hg lamp. A wavelength filter is used to select the 520 nm-550 nm wavelength band. The band has large overlap with absorption band of Cy3. Compared to the laser excitation, the laser often photobleaches the dyes due to its single wavelength and high power density. Different lasers are required to excite different dyes. Our light source has better efficiency for excitation and does not photobleach the sample. Furthermore, we only need to change the wavelength filter to excite other fluorescent dyes.

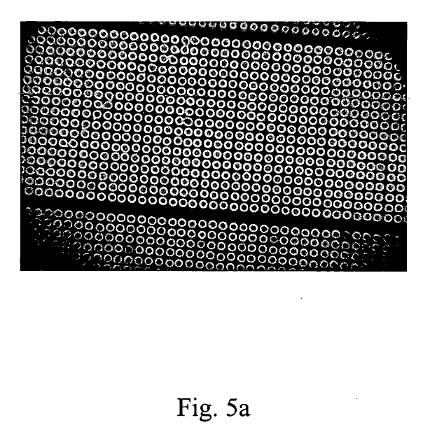

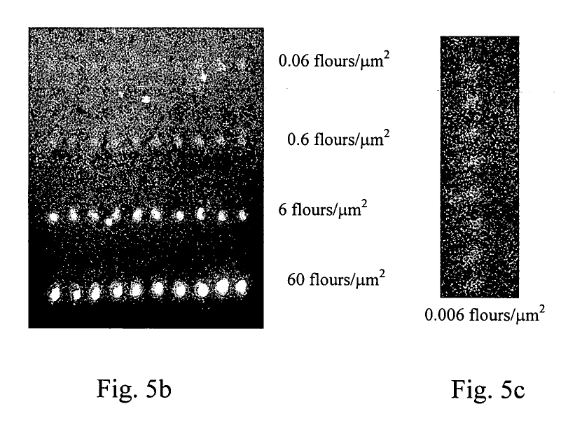

FIG. 5a shows the result of a large area test. We used a 580 nm bandpass filter to filter the unwanted background light. We can see micro arrays with 100 μm spot size. FIG. 5b shows the sensitivity test. The concentrations of Cy3 are 60 flours/μm², 6 flours/μm², 0.6 flours/μm² and 0.06 flours/μm², separately. The reading time is 30 seconds. We can clearly see fluorescence of low concentration Cy3 by this setup. The state-of-the-art microarray reader has the reading sensitivity of 0.1 flours/μm²˜0.02 flours/μm². See “The State of the Microarray: Selected Suppliers of Microarray Chips, Spotters, and Readers”, The Scientist, 17[3]:40, Feb. 10, 2003. Our invention uses simple optical setup, conventional white light source and low noise CCD to obtain comparable sensitivity in a short time. Furthermore, due to the low background characteristic of EPW, our invention can even obtain fluorescent image with much smaller concentration by elongating the exposure time. For example, FIG. 5c shows the fluorescent image of 0.006 flours/μm² of Cy3. The taken time is 3 minutes.

In conclusion, prior DNA microarray readers using CCD detection and white light excitation have advantages of large area, no scan units, and short reading time. But the excitation intensity is low and background is large compared to laser confocal scanning method. Our invention increases the power intensity by confining the light in a thin glass slide. Furthermore, the fluorescent tags are excited by the evanescent planar wave. It has very low background light. Hence, the sensitivity (signal/background noise) is greatly increased. We have achieved the sensitivity of 0.006 flours/um², which is one order of magnitude larger than the commercial product (Alpha Innotech, AlphaArray ) that using broadband light as source. Further, the broadband light is inherently incoherent. For multiple total internal reflections between the slides, there are no interference patterns. The surface can be large and uniformly illuminated.

The invention is not limited by the embodiments described above which are presented as examples only but can be modified in various ways within the scope of protection defined by the appended patent claims. All cited references are herein incorporated by reference in their entirety.

I claim:

1. A method for providing light onto a thin light transparent substrate, having an edge and two opposing surfaces, comprising the steps of:
passing noncoherent light through a fiber optic line light guide to produce line light;
impinging the line light onto the edge of the substrate to produce an evanescent planar wave on at least one of the surfaces of the substrate.

2. The method according to claim 1, wherein the line light impinges onto the edge of the substrate at an angle from the axis normal to the edge that is smaller than the internal reflection angle.

3. The method according to claim 2, wherein the angle is less than about 22°.

4. The method according to claim 1, wherein the light transparent substrate is selected from the group consisting of glass, quartz, ZnO, and ZrO₂.

5. The method according to claim 1, wherein the noncoherent light is white light.

6. The method according to claim 1, wherein the noncoherent light is filtered before passing through the fiber optic line light guide.

7. A method of detecting a fluorescent material on a thin light transparent substrate, having two opposing edges and two opposing surfaces, comprising the steps of:
passing noncoherent light through a fiber optic line light guide to produce line light;
impinging the line light onto at least one of the edge of the substrate to produce an evanescent planar wave on at least one of the surfaces of the substrate;
exciting the fluorescent material by the evanescent planar wave;
and detecting the emission from the fluorescent material.

8. The method of claim 7, further comprising the step of filtering the light emitted by the fluorescent material before detecting the emission.

9. The method of claim 7, further comprising the step of impinging the line light onto the two opposing edges of the substrate.

10. The method of claim 7, wherein the fluorescent material comprises a polynucleotide, protein or antibody.

11. The method of claim 7, wherein the emission from the fluorescent material is detected by a charge couple device.

12. The method of claim 7, wherein the noncoherent light is produced by a Hg lamp, Xe lamp or tungsten-halogen lamp.

13. The method according to claim 7, wherein the substrate is selected from the group consisting of glass, quartz, ZnO, and ZrO₂.

14. A system for detecting a fluorescent material on a thin light transparent substrate, having two opposing edges and two opposing surfaces, comprising:
a. a light source emitting an excitation white light;
b. a first fiber optic line light guide to convert the excitation white light into a line light, and to impinge the line light onto a first edge of the substrate to produce an evanescent planar wave on at least one of the surfaces of the substrate to thereby excite the fluorescent material; and
c. a detector to detect the emission from the fluorescent material.

15. The system of claim 14 further comprising a filter to filter the excitation white light before the light is passed into the fiber optic line light guide.

16. The system of claim 14 further comprising a filter to filter the emission from the fluorescent material before the emission is detected by the detector.

17. The system of claim 14 wherein the line light impinges onto the edge of the substrate by end-fire coupling.

18. The system of claim 14 wherein the detector is a charge couple device.

19. The system according to claim 14, further comprising a second fiber optic line light-guide to impinge the line light onto a second edge of the substrate opposite the first edge.

20. The system according to claim 14, wherein said light source is Hg lamp, Xe lamp or Tungsten-Halogen lamp.

21. The system according to claim 14, wherein the fluorescent material is a fluorescently-labeled sample.

22. The system according to claim 14, wherein the fluorescently-labeled sample comprises a polynucleotide, a protein or an antibody.

23. The system according to claim 14, wherein the substrate is selected from the group consisting of glass, quartz, ZnO, and ZrO₂.
